(19) United States
(12) Patent Application Publication
(10) Pub. No.: US 2024/0223999 A1
(43) Pub. Date: Jul. 4, 2024

(54) UWB-BASED INDOOR POSITIONING SYSTEM AND METHOD USING OUT-OF-BAND MANAGEMENT

(71) Applicant: KOREA UNIVERSITY RESEARCH AND BUSINESS FOUNDATION, Seoul (KR)

(72) Inventors: Hwangnam KIM, Seoul (KR); Sang-Min Lee, Seoul (KR); KyeongHyun Yoo, Seoul (KR)

(21) Appl. No.: 18/399,813

(22) Filed: Dec. 29, 2023

(30) Foreign Application Priority Data
Dec. 29, 2022 (KR) 10-2022-0188554

(51) Int. Cl. H04W 4/029; H04W 4/33

(52) U.S. Cl. CPC H04W 4/029; H04W 4/33

(57) ABSTRACT

An UWB-based indoor positioning system using out-of-band management includes a plurality of nodes that individually broadcast an UWB broadcast message through an ultra-wide band (UWB) channel; and a remote positioning server for receiving a response message to the UWB broadcast message through an out-of-band network, calculating a time of flight (ToF) between the nodes based on the identification information and timestamp information of each of the nodes included in the response message and producing a positioning information of each of the nodes by calculating a distance between the nodes using the calculated ToF. The UWB-based indoor positioning system and method using out-of-band management can significantly improve node scalability and flexibility in the UWB positioning system through the unification of processes between anchor/tag nodes and simplification of the initial registration procedure.

### CROSS-REFERENCE TO RELATED APPLICATION

This application claims the benefit of the Korean Patent Application No. 10-2022-0188554 filed Dec. 29, 2022, which is incorporated herein by reference in its entirety incorporated into the specification.

### TECHNICAL FIELD

The present disclosure relates to an indoor positioning system and method, and more specifically, to an ultra-wide band based (UWB-based) indoor positioning system and method using an out-of-band management.

### BACKGROUND

A location determination technology (LDT) is a technology for estimating the static or dynamic location of a terminal.

The location determination technology may be broadly divided into a network-based technique that utilizes signals received from a base station in a communication network, a terminal-based technique that uses a GPS receiver, etc. mounted on a terminal, and a hybrid technique that uses a combination of the above two techniques.

In such techniques, positioning methods may be classified as follows: an Angle of Arrival (AoA) method that measures the angle of arrival of the signal incoming to a terminal from a base station in order to determine the location of the terminal, a Time Difference of Arrival (TDOA) method that uses the relative difference in the time of arrivals of radio waves from two base stations, a satellite communication method that determines the location by attaching a GPS to the terminal, and a frequency pattern matching method that determines the location using a radio camera.

The Indoor Positioning System (IPS) is a system that estimates the location of a static or dynamic terminal existing indoor and applies the estimated location to various businesses.

The IPS includes a technology that compositely positions various types of wireless signals to determine an accurate location and a technology that constructs and maps a digital map based on signals, etc. In these techniques, radio waves, magnetic fields or various sensor information are used to identify and utilize the location of objects or people within a building with the minimum margin of error. Technologies utilizing them are applied and utilized in various Internet of Thing (IOT) related fields such as distribution, logistics, health cares and production facilities.

An Ultra-Wideband (UWB) Wireless technology is a radio technology that is applied to communications or radar, etc. using very-wide frequency bands of several GHz or more in the baseband, without using a wireless carrier.

Since the UWB radio technology uses very narrow pulses of a few nanoseconds or picoseconds, it can share frequencies with existing communication systems such as mobile communication, broadcasting and satellite without mutual interference with very low spectrum power such as the noise of existing wireless systems, and thus is emerging as a system that can be used without frequency restrictions. This technology is used in various fields such as a military radar, an anti-collision radar, intruder detection, location verification, and communication.

Because radio wave signals received from the ground in case of GPS are weak, the LTD technology is vulnerable to interference from other radio waves and has difficult problems in performing positioning in environments where a Line of Sight (LOS) is not guaranteed, such as indoors, canyons and underground. In addition, the accuracy of the positioning in a positioning technology using Wi-Fi, etc. varies greatly depending on the number and placement of surrounding signal sources (Access Points (AP)).

In the indoor positioning system (IPS), the wireless communication environment is also very variable as indoor spaces become more complex and the mobility of people and structures is high. Since the unstable wireless communication environment is the main factor that deteriorates the precision of wireless communication-based positioning, various methods have been introduced to solve this problem, but it still shows many shortcomings in terms of precision.

The UWB requires an expensive UWB-based module for positioning, and the complexity in building-up a system is high. In outdoor environments, international regulations limit frequency width to 450 MHz or higher and signal strength to −41.3 dBm or lower, which limits long-distance communications. In addition, existing UWB positioning technology has the disadvantage that as the number of positioning nodes increases, the number of messages exchanged between nodes increases exponentially, causing network congestion and positioning delays.

### PRIOR ART LITERATURE

Registered Korean Patent Publication No. 10-2353600 (2022.01.17)

The problems to be solved by the present disclosure is to provide an UWB-based indoor positioning system and method using out-of-band management.

The problems to be solved by the present disclosure are not limited to those mentioned above, and other problems not mentioned will be clearly understood by those skilled in the art from the description below.

### SUMMARY

An UWB-based indoor positioning system using out-of-band management according to one embodiment of the present disclosure includes a plurality of nodes that individually broadcast an UWB broadcast message through an ultra-wide band (UWB) channel; and a remote positioning server for receiving a response message to the UWB broadcast message through an out-of-band network, calculating a time of flight (ToF) between the nodes based on identification information and timestamp information of each of the nodes included in the response message and producing a positioning information of each of the nodes by calculating a distance between the nodes using the calculated ToF.

Preferably, the remote positioning server further transmits a broadcast command message to each of the nodes through the out-of-band network, and receives, from each of the nodes, unicast message for registering each of the nodes and a broadcast completion report message.

Preferably, the minimum number of the plurality of nodes is determined depending on a positioning dimension, and nodes exceeding a threshold are registered for two-dimensional positioning of a certain node.

Preferably, the out-of-band network is a wired network or a wireless network.

Preferably, the remote positioning server goes around each of the nodes at intervals T and transmits the broadcast command message to each node.

Preferably, whenever an additional response message is received from each of the nodes, the remote positioning server sequentially calculates the distance between the nodes using additional timestamp information included in the additional response message and the timestamp information stored in the remote positioning server.

An UWB-based indoor positioning method using out-of-band management according to one embodiment of the present disclosure comprises the steps of: receiving, by a remote positioning server, a unicast message for registration from a plurality of nodes through an out-of-band network; going around, by the remote positioning server, each of the nodes at intervals T and transmitting a broadcast command message to each node through the out-of-band network; sequentially broadcasting, by each of the nodes that have received the broadcast command message, a UWB broadcast message through an ultra-wideband (UWB) channel; sequentially receiving, by the remote location server, a broadcast completion report message from each of the nodes through the out-of-band network, after the completion of broadcasting; sequentially receiving, by the remote positioning server, a response message to the UWB broadcast message from each of the nodes through the out-of-band network; calculating, by the remote positioning server, a Time of Flight (ToF) between the nodes based on the node identification information and timestamp information included in the response message; calculating, by the remote location server, a distance between the nodes using the calculated ToF; and producing, by the remote positioning server, positioning information for each of the nodes using the calculated distance between the nodes.

Preferably, the minimum number of the plurality of nodes is determined depending on a positioning dimension, and nodes exceeding a threshold are registered for two-dimensional positioning of a certain node.

Preferably, the out-of-band network is a wired network or a wireless network.

Preferably, the remote positioning server goes around each of the nodes at intervals T and transmits the broadcast command message to each node.

Preferably, whenever an additional response message is received from each of the nodes, the remote positioning server sequentially calculates the distance between the nodes using additional timestamp information included in the additional response message and the timestamp information stored in the remote positioning server.

Specific details of other embodiments are included in the detailed description and drawings.

### Advantageous Effects of the Invention

The UWB-based indoor positioning system and method utilizing out-of-band management according to an embodiment of the present disclosure can expand node scalability and flexibility in the UWB positioning system through unification of processes between anchor/tag nodes and simplification of the initial registration procedure.

The UWB-based indoor positioning system and method using out-of-band management according to an embodiment of the present disclosure can significantly improve the positioning delay for high-speed moving objects by utilizing an out-of-band network and subdividing the distance derivation process compared to the existing system.

The UWB-based indoor positioning system and method utilizing out-of-band management according to an embodiment of the present disclosure can prevent the accuracy of positioning from being degraded due to channel noise.

The UWB-based indoor positioning system and method using out-of-band management according to an embodiment of the present disclosure can be applied to the positioning of high-speed moving objects that require advanced positioning by time and have high time sensitivity.

The UWB-based indoor positioning system and method using out-of-band management according to an embodiment of the present disclosure is easy to be grafted onto fields requiring multiple positioning objects (tags), and thus it can be applied to a positioning systems for multiple dynamic objects such as drone formation operation in the defense logistics or distribution fields.

However, the effects of the present disclosure are not limited to those mentioned above, and other effects not mentioned will be clearly understood by those skilled in the art from the description below.

### BRIEF DESCRIPTION OF THE DRAWINGS

FIG. 1 is a schematic diagram of an UWB-based indoor positioning system using out-of-band management according to an embodiment of the present disclosure.

FIG. 2 is a diagram illustrating message delivery between a remote positioning server and a node in an UWB-based indoor positioning system using out-of-band management according to an embodiment of the present disclosure.

FIG. 3 is a diagram illustrating a Double-sided Two Way Ranging (DS-TWR) technique for calculating the distance between nodes of an UWB-based indoor positioning system using out-of-band management according to an embodiment of the present disclosure.

FIG. 4 is a flowchart of an UWB-based indoor positioning method using out-of-band management according to an embodiment of the present disclosure.

FIG. 5 is a flowchart of an UWB-based indoor positioning method using out-of-band management according to another embodiment of the present disclosure.

FIG. 6 is a diagram showing the results of an experiment to verify the accuracy of positioning of an UWB-based indoor positioning system and method using out-of-band management according to an embodiment of the present disclosure.

FIG. 7 is a result showing the positioning error with ground truth for five nodes of an UWB-based indoor positioning system and method using out-of-band management according to an embodiment of the present disclosure.

FIG. 8 is a result diagram showing the results of a positioning delay experiment using unmanned ground vehicle (UGV) and unmanned aerial vehicle (UAV) of an UWB-based indoor positioning system and method using out-of-band management according to an embodiment of the present disclosure.

FIG. 9 is a diagram illustrating an exemplary computing device that implements devices and/or systems according to various embodiments of the present disclosure.

### DETAILED DESCRIPTION

The advantages and features of the present invention and methods for achieving them will become clear by referring to the embodiments described in detail below along with the accompanying drawings. However, the present invention is not limited to the embodiments disclosed below and may be implemented in various different forms. The present embodiments are merely provided to ensure that the disclosure of the present invention is complete and to fully inform those skilled in the art to which the present invention pertains of the scope of the invention. The present invention is only defined by the scope of the claims. Like reference numerals refer to like elements throughout the specification.

Embodiments described in the present specification will be explained with reference to cross-sectional views and/or plan views, which are ideal illustrations of the present invention. In the drawings, the thickness of the components is exaggerated for effective explanation of technical content. Accordingly, the configurations illustrated in the drawings have schematic properties, and the shapes of the configurations illustrated in the drawings are intended to illustrate specific forms of the configuration and are not intended to limit the scope of the invention. In various embodiments of the present specification, terms such as first, second and third are used to describe various components, but these components should not be limited by these terms. These terms are merely used to distinguish one component from another. Embodiments described and illustrated herein also include complementary embodiments thereof.

The terminologies used herein are for describing embodiments and are not intended to limit the invention. As used herein, singular forms also include plural forms, unless specifically stated otherwise in the context. As used in the specification, “comprises” and/or “comprising” do not exclude the presence or addition of one or more other components, steps, operations and/or elements in the mentioned components, steps, operations and/or elements.

Unless otherwise defined, all terms (including technical and scientific terms) used in this specification may be used with meanings that can be commonly understood by those skilled in the art to which the present invention pertains. Additionally, terms defined in commonly used dictionaries are not interpreted ideally or excessively unless clearly specifically defined.

Hereinafter, with reference to the drawings, the concept of the present invention and embodiments thereof will be described in detail.

The existing UWB positioning system includes a process for a tag node to find an anchor node. Additionally, each tag node performs a ranging process separated from all anchor nodes. The process for a tag node to find an anchor node increases the delay rate of the entire system in proportion to the number of tag nodes.

The UWB-based indoor positioning system and method using out-of-band management of the present disclosure are proposed to solve the problems of the conventional UWB positioning system, and may be summarized as 1) reducing the network delay rate of the UWB positioning system using a simplified process and 2) alleviating network congestion in the UWB positioning system.

The present disclosure simplifies the process of finding an anchor node in the UWB positioning process and reduces the number of UWB messages that are exchanged in the UWB channels by transmitting and receiving timestamp data through an out-of-band network.

The purpose of the present disclosure is to reduce positioning delay by relieving the congestion in the UWB positioning system through a series of processes.

The present disclosure is characterized by reducing the delay rate of the UWB-based indoor positioning by using the out-of-band management. The present disclosure deals with an indoor positioning technology using UWB among various technologies for performing positioning in the indoor space where GPS signals are difficult to receive.

The UWB-based indoor positioning system and method using out-of-band management of the present disclosure is characterized by reducing the time required for the entire positioning process by employing a separate control channel when implementing the UWB-based positioning technology. To this end, the present disclosure deals with overall network management technologies for various channels such as Wi-Fi and ultra-wideband. The present disclosure reduces the delay rate of UWB positioning information update and may be applied to high time-sensitive applications, that is, a real time location system (RTLS).

The present disclosure may implement a low-delay positioning technique through segmentation of the distance derivation process, which is an essential element in a distance-based indoor positioning system. The present disclosure does not limit the subject that uses the positioning system to static nodes, and can also be used for high-precision and low-delay positioning of dynamic nodes such as the UGV and UAV.

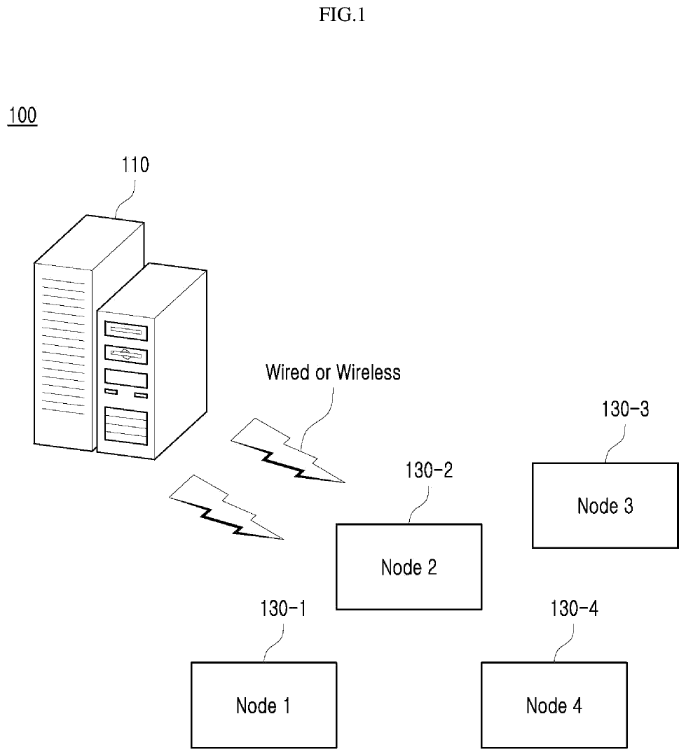

FIG. 1 is a schematic diagram of an UWB-based indoor positioning system using out-of-band management according to an embodiment of the present disclosure.

The UWB-based indoor positioning system 100 using the out-of-band management according to an embodiment of the present disclosure includes a remote positioning server 110 and a plurality of nodes 130-1 to 130-4.

In FIG. 1, the number of nodes is shown as four 4, but this is only an example and is not limited thereto.

Communication between the remote positioning server 110 and the nodes 130-1 to 130-4 uses a wired network and/or a wireless network, for example, LTE or Wi-Fi.

The plurality of nodes 130-1 to 130-4 individually broadcast an UWB broadcast message through an UWB channel.

The remote positioning server 110 receives a response message to the UWB broadcast message through the out-of-band network, calculates a Time of Flight (Tof) between the nodes based on identification information and timestamp information of each node included in the response message, and produces positioning information for each node by calculating the distance between the nodes using the calculated ToF.

The remote positioning server 110 further transmits a broadcast command message to each node 130-1 to 130-4 through the out-of-band network, and receives a unicast message for registration of each node and a broadcast completion report message from each node 130-1 to 130-4.

The minimum number of the plurality of nodes is determined depending on the positioning dimensions.

The minimum number of nodes required for two-dimensional positioning of a certain node is three.

The remote positioning server 110 of the present disclosure calculates the distance between the nodes using a double-sided two way ranging (DS-TWR) technique.

The remote positioning server 110 goes around each of the nodes at intervals T and transmits a broadcast command message to each node.

Whenever receiving a new response message from each node, the remote positioning server 110 sequentially calculates the distance between the nodes using new timestamp information included in the new response message and the timestamp information stored in the remote positioning server.

The nodes 130-1 to 130-4 of the present disclosure may be a person (s) wearing an USB module or a device (s) equipped with the UWB module, which is fixed or movable.

As an example, the UWB module monitors the movements of a person (s) wearing the UWB module and derives information on the speed, distance and direction, etc. of a soccer player, a baseball player and the like, for example, in ball games.

Using the UWB module of the present disclosure, the positions of players and balls in ball games can be tracked, and various information for player management can be derived using them.

As an example, nodes 130-1 to 130-4 may be drones equipped with the UWB module, and this is not limited thereto.

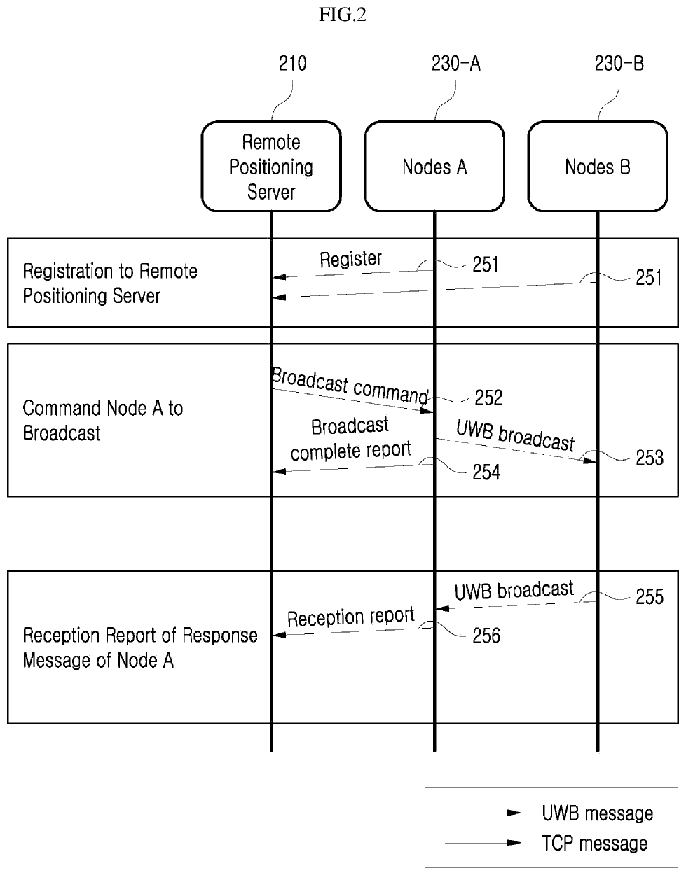

FIG. 2 is a diagram illustrating message delivery between a remote positioning server and a node in an UWB-based indoor positioning system using the out-of-band management according to an embodiment of the present disclosure.

The present disclosure is a technology for mitigating positioning delay in the UWB-based positioning system. The present disclosure includes the following two features:

1. All UWB modules are designed to perform the same operation without the separation between anchor and tag.

### Unification of Anchor/Tag Node Operations

In an existing distance-based positioning system, the number of necessary anchor nodes is determined based on the required positioning dimensions. When estimating the two-dimensional location of a tag node, at least three anchor nodes are necessary, and for three-dimensional location, at least four anchor nodes are necessary.

As mentioned earlier, in the present disclosure, all anchor and tag nodes perform the same operation throughout the entire process.

In the existing UWB positioning system, anchor/tag nodes perform independent processes and thus, a clear role definition was needed from the beginning of the system.

However, in the present disclosure, all nodes perform the same process, which has an advantage in scalability. That is, it is possible to flexibly switch the role of anchor/tag, and by increasing or decreasing the number of tag nodes, the item and number of nodes targeted for positioning can be adjusted relatively easily.

In the existing UWB positioning system, anchor and tag nodes perform different operations and thus, a system input is first required to separate the nodes.

In contrast, the present disclosure has strengths in system flexibility and scalability by avoiding the separated processes of anchor and tag nodes in the existing UWB system and designing the system with the same type of process.

In addition, the present disclosure can realize low-delay positioning for high-speed objects by introducing a sequential distance derivation system, rather than the existing distance derivation based on three message information, in the distance derivation step.

The existing UWB positioning system has an existing anchor/tag node structure with separated operations and thus, each tag node performs a separate positioning process, thereby increasing the time required for positioning in proportion to the number of tag nodes.

The present disclosure simplifies the structure by eliminating the separation between anchors and tags and unifying the operations, thereby simplifying the process of determining the modules and number of tag role nodes that will perform positioning among all deployed nodes and minimizing a positioning delay due to the number of the positioning modules.

2. Positioning data management using the out-of-band network.

### Message Control Through the Out-of-Band Network

In the present disclosure, the overall overhead of the positioning system is reduced by controlling UWB message using the out-of-band network. This has a great advantage in terms of positioning delay for fast-moving objects. In the case of fast-moving objects such as drones, even a slight delay in the positioning system causes large positioning errors.

This is because the location estimated at the present time is actually the location of tens to hundreds of ms in the past. The structure of message control through the out-of-band network is described below with reference to FIG. 2.

In the present disclosure, since the anchor and the tag perform the same operation, they are called node or ranging node without separation therebetween.

Unlike the existing positioning method in which all messages are transmitted and received through the UWB channel, the present disclosure adopts a method in which only messages that are broadcasted in turn by each node are transmitted through the UWB channel.

In addition, a unicast message for initial node registration, a broadcast command message transmitted from the remote positioning server, and a broadcast completion report message transmitted from each node to the remote positioning server and a response message to the UWB message are all transmitted and received through the out-of-band network.

As the out-of-band network, various networks such as Wi-Fi and LTE may be employed, and in an embodiment of the present disclosure, Wi-Fi is used as an example, but this is not limited thereto.

By employing an additional network for message control and separating transmitted and received messages by each channel unlike existing systems, the present disclosure has advantages of preventing the bottleneck that may occur in the entire positioning process and resultantly reducing a positioning delay.

The present disclosure includes a process of deriving the distances between nodes for all nodes registered in the remote positioning server, and in this process, all messages except the UWB broadcast message are transmitted and received through the out-of-band network.

This out-of-band management provides the effects of significantly reducing the number of messages transmitted and received through the UWB channel and mitigating delays in the overall positioning process.

FIG. 2 is a diagram showing a message delivery between the remote positioning server 210 and nodes 230-A and 230-B in the UWB-based indoor positioning system using the out-of-band management according to an embodiment of the present disclosure.

As shown in FIG. 2, the message transmitted and received through the UWB channel is only UWB broadcast messages 253 and 255 between node A (230-A) and node B (230-B).

All messages except the UWB broadcast message, that is, a unicast message 251 for initial node registration, a broadcast command message 252 transmitted from the remote positioning server, and a broadcast completion report message 254 transmitted from each node to the remote positioning server and a response message 256 to the UWB message are configured to be transmitted and received through the out-of-band network.

As shown in FIG. 2, communications between the remote positioning server 210, nodes 230-A and nodes 230-B are all transmitted and received through the out-of-band network.

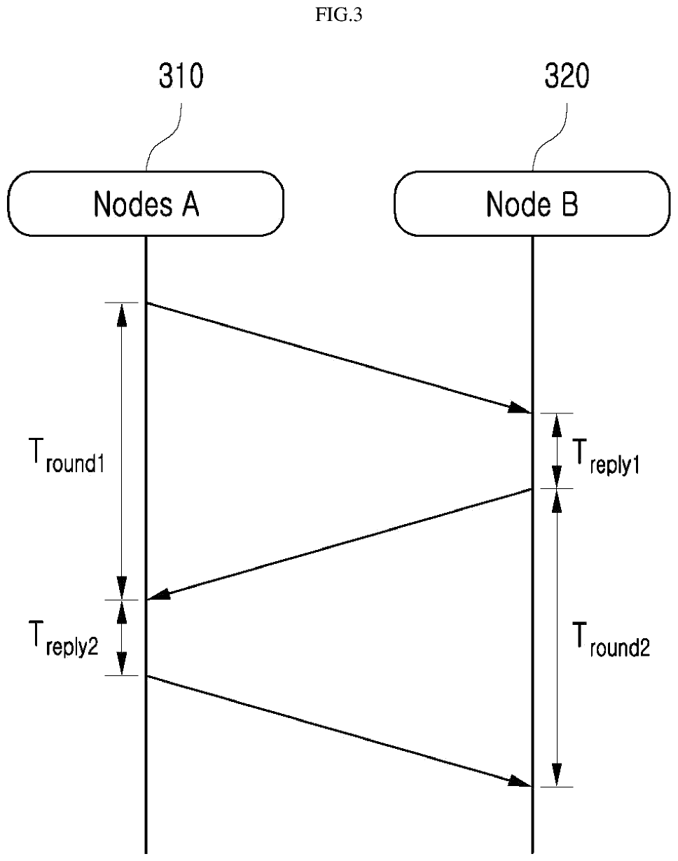

FIG. 3 is a diagram illustrating a double-sided two way ranging (DS-TWR) technique for calculating the distance between nodes of the UWB-based indoor positioning system using the out-of-band management according to an embodiment of the present disclosure. The remote location server calculates the distance between the nodes using the DS-TWR technique.

The DS-TWR technique is used when the number of message exchanges between respective nodes reaches 3 to thereby produce the distance between the nodes. The detailed method of the DS-TWR is shown in FIG. 3.

For node positioning, each message includes node identification information (ID) and timestamp information of a corresponding device at the time of transmission.

In order to produce distance information, a time of flight (ToF) is first calculated.

T_{round1} at node A 310 and T_{round2} at node B 320 are calculated based on Equation 1.

$$\\ \begin{matrix}{T}_{round 1} = μ ( 2 {T}_{f} + {T}_{reply 1} ) + θ , where , & [ Equation 1 ]\end{matrix}$$

$$\\ μ is control parameter and θ is processing delay .$$

$$\\ {T}_{round 2} = ε ( 2 {T}_{f} + {T}_{reply 2} ) + φ , where ,$$

$$\\ ε is control parameter and φ is processing delay .$$

Multiplying T_{round1} by T_{round2} results in Equation 2:

$$\\ \begin{matrix}{T}_{round 1} {T}_{round 2} = 2 {T}_{f} ( 2 ε μ {T}_{f} + ε μ {T}_{reply 1} + ε μ {T}_{reply 2} + ε θ + μ φ ) + μ φ {T}_{reply 1} + ε θ {T}_{reply2} + ε μ {T}_{reply 1} {T}_{reply 2} + θ φ & [ Equation 2 ]\end{matrix}$$

Organizing the terms to obtain ToF results in Equation 3:

$$\\ \begin{matrix}{T}_{round 1} {T}_{round 2} - ( μ φ {T}_{reply 1} + ε θ {T}_{reply 2} + ε μ {T}_{reply 1} {T}_{reply 2} + θ φ ) = 2 {T}_{f} ( ε {T}_{round 1} + ε μ {T}_{reply 2} + μ φ ) & [ Equation 3 ]\end{matrix}$$

Finally, ToF is calculated as Equation 4:

$$\\ \begin{matrix}{T}_{f} = \frac{{T}_{round 1} {T}_{round 2} - ( \begin{matrix}μ φ {T}_{reply 1} + ε θ {T}_{reply 2} + \\ ε μ {T}_{reply 1} {T}_{reply 2} + θ φ\end{matrix} )}{2 ( ε {T}_{round 1} + ε μ {T}_{reply 2} + μ φ )} & [ Equation 4 ]\end{matrix}$$

The distance between the nodes is generally calculated by multiplying the produced ToF by the propagation speed of signals. In the present disclosure, the distance between the nodes are calculated as in Equation 5.

$$\\ \begin{matrix}d = α * {t}_{ToF} + β & [ Equation 5 ]\end{matrix}$$

where α and β are proportionality constant.

Ultimately, the node's positioning information is produced based on the distance information derived between all nodes.

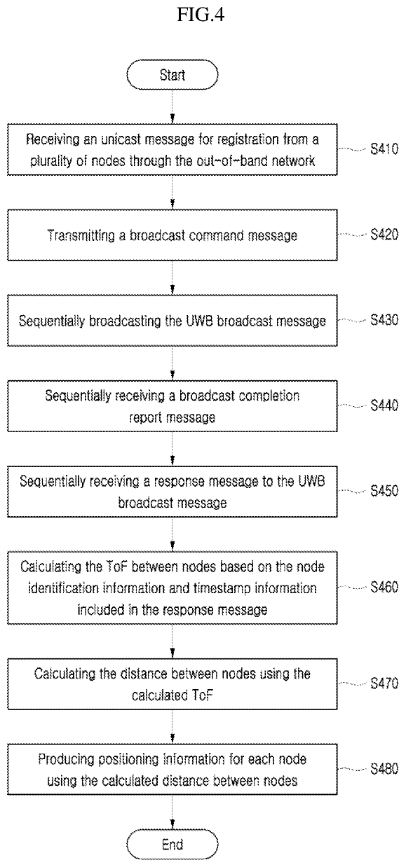

FIG. 4 is a flowchart of an UWB-based indoor positioning method using the out-of-band management according to an embodiment of the present disclosure.

In the UWB-based indoor positioning method using the out-of-band management according to an embodiment of the present disclosure, a remote positioning server 110 receives a unicast message for registration from a plurality of nodes through the out-of-band network at step S410.

The remote positioning server 110 goes around each of the nodes at intervals T and commands each node to broadcast an UWB message at step S420.

Each node that has received the broadcast command message from the remote positioning server 110 sequentially broadcasts the UWB broadcast message through the UWB channel at step S430.

After the completion of the broadcasting, the remote positioning server 110 sequentially receives a broadcast completion report message from each node through the out-of-band network at step S440.

Through the out-of-band network, the remote positioning server 110 sequentially receives a response message to the UWB broadcast message from each node at step S450.

The remote positioning server 110 calculates the ToF between the nodes based on the node identification information and timestamp information included in the response message at step S460.

The remote positioning server 110 calculates the distance between nodes using the calculated ToF at step S470.

The remote positioning server 110 produes positioning information for each node using the calculated distance between nodes at step S480.

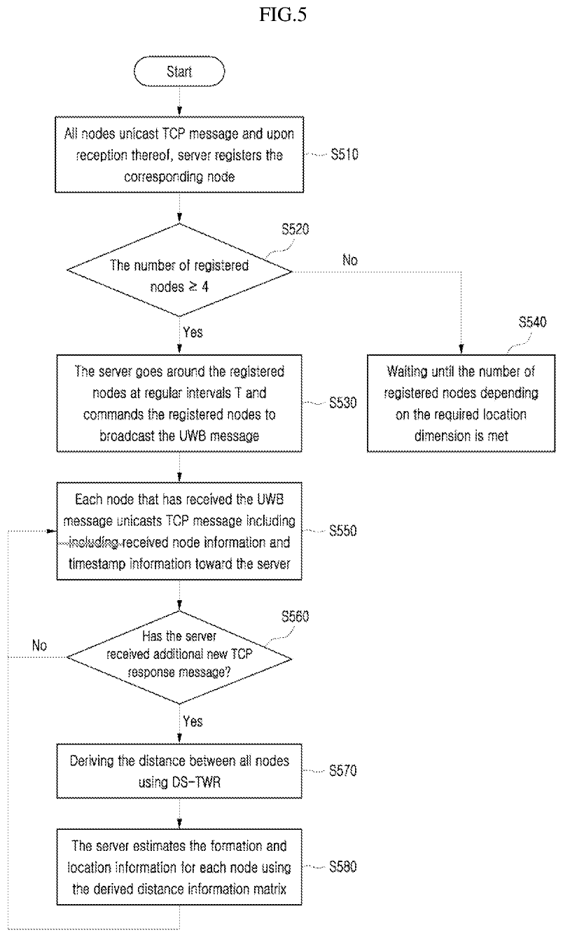

FIG. 5 is a flowchart of an UWB-based indoor positioning method using the out-of-band management according to another embodiment of the present disclosure.

FIG. 5 is a flowchart of an UWB-based indoor positioning method using the out-of-band management using TCP message for the out-of-band network.

As mentioned above, when the positioning process starts, all nodes perform a node registration by unicasting a TCP message to the remote positioning server through the out-of-band network at step S510.

The minimum number of registered nodes is determined based on positioning dimensions requested by the user at step S520. For 3-dimensional positioning, at least four nodes are necessary.

If the minimum number of the registered nodes falls short, the remote positioning server waits until the number of the registered nodes according to the required location dimension is met at step S540.

When the minimum number of the registered nodes is met, the remote positioning server goes around each of the nodes at regular intervals T and commands each node to broadcast an UWB message at step S530.

Each node that has received the command message broadcasts the UWB message, and all nodes that have received the corresponding UWB message Transmission Control Protocol (TCP) response messages each of which includes node identification information and timestamp information of the node receiving the broadcasted UWB message, to the remote positioning server at step S550.

The UWB-based indoor positioning method using the out-of-band management according to another embodiment of the present disclosure can realize low-delay positioning for high-speed objects by introducing a sequential distance derivation system rather than the existing distance derivation based on three message information.

Accordingly, the remote positioning server determines whether a new TCP response message has been received from the node at step S560.

Upon receiving the new TCP response message, the remote positioning server derives the distance between nodes using the DS-TWR at step S570.

The remote positioning server estimates or calculates measurement information for each node using the derived distance information at step S580.

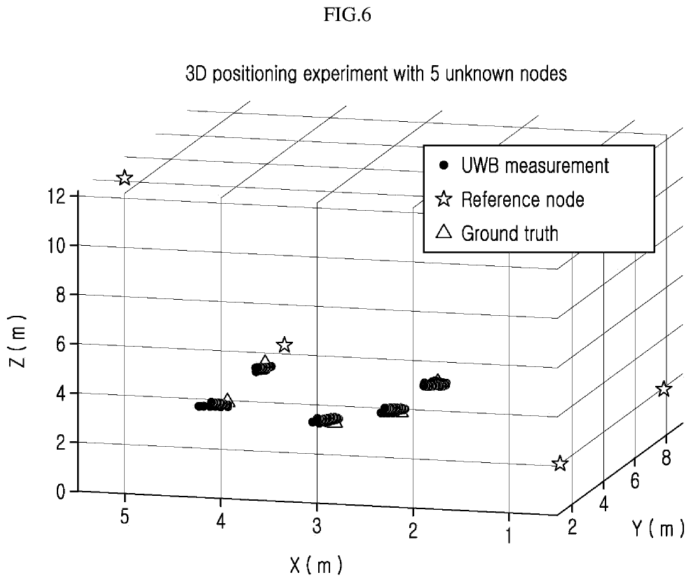

FIG. 6 is a diagram showing the results of an experiment performed to verify the accuracy of positioning in an UWB-based indoor positioning system and method using the out-of-band management according to an embodiment of the present disclosure.

FIG. 6 shows the results of an experiment performed to verify the accuracy of positioning for a static node by using nine nodes including five tag nodes. FIG. 6 is the results showing the positioning error with ground truth for each of the five nodes.

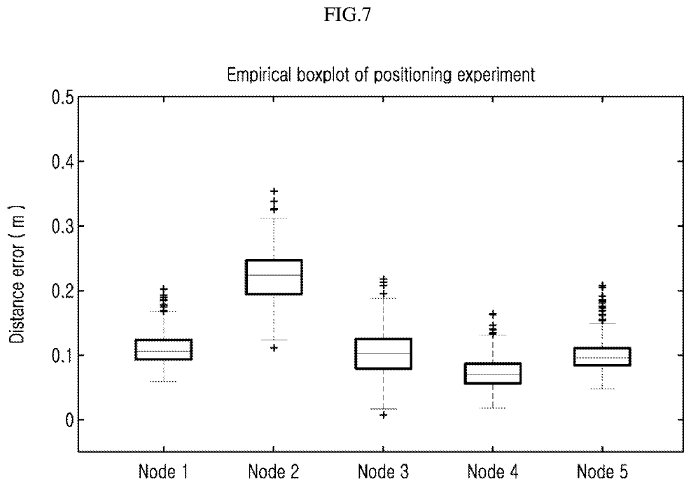

FIG. 7 is the results showing the positioning error with ground truth for five nodes in the UWB-based indoor positioning system and method using the out-of-band management according to an embodiment of the present disclosure.

In FIG. 7, the actual results of deriving positioning information at regular intervals are shown in bold boxes. As a result of the experiment, positioning errors of approximately 10 cm are shown for all nodes.

From the results of FIG. 7, it can be seen that the UWB-based indoor positioning system and method using the out-of-band management according to an embodiment of the present disclosure is at or exceeds the general UWB positioning error level.

The UWB-based indoor positioning system and method using the out-of-band management according to an embodiment of the present disclosure have the advantage of reducing the influence of noise within the UWB channel through a separation of message transmission and reception and therefore, it can be seen that the accuracy of positioning has also been improved from the experimental results of FIGS. 6 and 7.

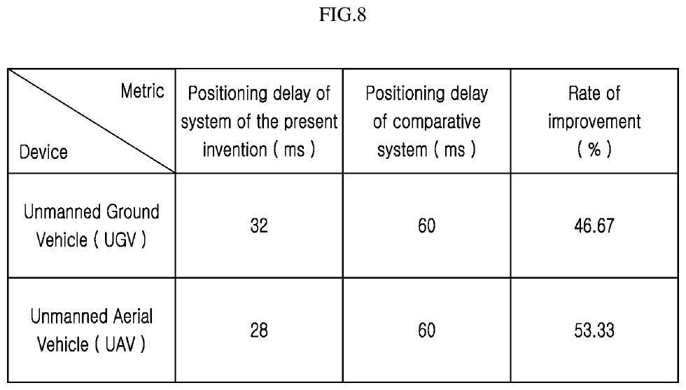

FIG. 8 is a diagram showing the results of a positioning delay experiment using an unmanned ground vehicle (UGV) and an unmanned aerial vehicle (UAV) of the UWB-based indoor positioning system and method using the out-of-band management according to an embodiment of the present disclosure.

The present disclosure has strengths in terms of positioning delay through simplification of the anchor/tag node structure and process and the adoption of out-of-band channel.

FIG. 8 shows the results of the positioning delay experiment of a dynamic tag node using the UGV and UAV. In this experiment, the UWB-based indoor positioning system in accordance with an embodiment of the present disclosure used an opti-track which is a high-performance optical motion capture equipment in order to measure a system positioning delay.

Calculating the ground truth for a dynamic object is an uneasy problem, and therefore, under the assumption that the results of the opti-track are to be the ground truth, the positioning delay has been measured by comparing the system delay of the opti-track with the positioning results of the present disclosure.

As a result of the measurement, it has been verified that the positioning delay in the present disclosure is 32 ms and 28 ms for the UGV and UAV, respectively and has been improved by about 46% and 53% compared to the existing comparative UWB module (DW1000 system delay of about 60 ms).

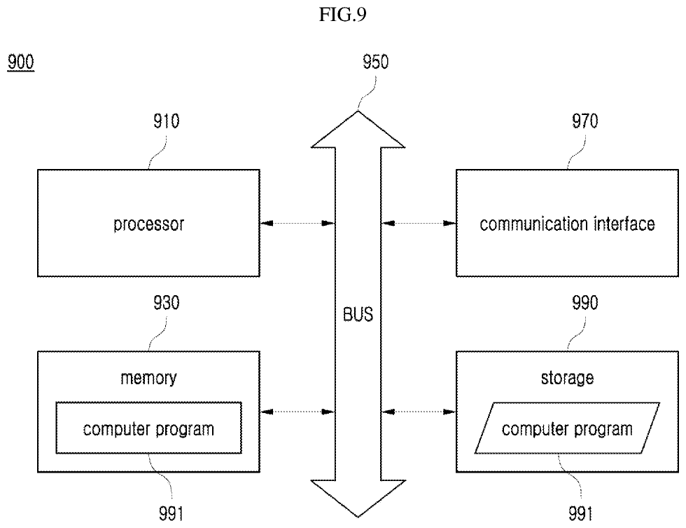

FIG. 9 is a diagram illustrating an exemplary computing device capable of implementing the devices and/or systems according to various embodiments of the present disclosure.

An exemplary computing device 900 capable of implementing devices according to some embodiments of the present disclosure will be described in more detail with reference to FIG. 9.

The computing device 900 includes one or more processors 910, a bus 950, a communication interface 970, a memory 930 that loads a computer program 991 executed by the processor 910, and a storage 990 that stores the computer program 991. The components of the computing device 900 shown in FIG. 9 are only exemplary, however, not limited thereto.

Accordingly, those skilled in the art to which the present disclosure pertains can recognize that other general-purpose components may be further included in addition to the components shown in FIG. 9.

The processor 910 controls the overall operations of respective components of the computing device 900. The processor 910 includes a central processing unit (CPU), a micro processing unit (MPU), a micro controller unit (MCU), a graphic processing unit (GPU), or any type of processor well known in the art of the present disclosure. Additionally, the processor 910 performs an operation on at least one application or program to execute methods according to embodiments of the present disclosure. The computing device 900 includes one or more processors. The computing device 900 may refer to an artificial intelligence (AI).

The memory 930 stores various kinds of data, commands and/or information. The memory 930 loads one or more programs 991 from the storage 990 to execute methods according to embodiments of the present disclosure. The memory 930 may be implemented as a volatile memory such as RAM, but the technical scope of the present disclosure is not limited thereto.

The bus 950 provides communication functionality between the components of the computing device 900. The bus 950 may be implemented as various types of buses such as an address bus, a data bus and a control bus.

The communication interface 970 supports wired and wireless Internet communications of the computing device 900. Additionally, the communication interface 970 supports various communication methods other than Internet communications. To this end, the communication interface 970 may be configured to include a communication module well known in the technical field of the present disclosure.

According to some embodiments, the communication interface 970 may be omitted.

The storage 990 non-transitorily stores the one or more programs 991 and various data.

The storage 990 may be configured to include a non-volatile memory such as a read only memory (ROM), an erasable programmable ROM (EPROM), an electrically erasable programmable ROM (EEPROM) and a flash memory, a hard disk, a removable disk, or any type of computer-readable recording medium well known in the technical field to which the present disclosure pertains.

The computer program 991, when loaded into the memory 930, includes one or more instructions that cause the processor 910 to perform methods/operations according to various embodiments of the present disclosure. That is, the processor 910 performs the methods/operations according to various embodiments of the present disclosure by executing the one or more instructions.

In the above, preferred embodiments of the present invention have been shown and described, but the present invention is not limited to the specific embodiments described above. Various modifications can be made by those skilled in the art to which the present invention pertains without departing from the gist of the present invention as claimed in the claims and these modifications should not be understood separately from the technical idea or perspective of the present invention.

What is claimed is:

1. An ultra-wide band (UWB)-based indoor positioning system using out-of-band management, comprising:
a plurality of nodes that individually broadcast an UWB broadcast message through an UWB channel; and
a remote positioning server configured to receive a response message to the UWB broadcast message through an out-of-band network, calculate a time of flight (ToF) between the nodes based on identification information and timestamp information of each of the nodes included in the response message, and produce a positioning information of each of the nodes by calculating a distance between the nodes using the calculated ToF.

2. The UWB-based indoor positioning system according to claim 1, wherein the remote positioning server is further configured to transmit a broadcast command message to each of the nodes through the out-of-band network, and receive, from each of the nodes, a unicast message for registering each of the nodes and a broadcast completion report message through the out-of-band network.

3. The UWB-based indoor positioning system according to claim 1, wherein a minimum number of the plurality of nodes is determined depending on a positioning dimension, and the nodes of which number exceeds a threshold are registered for two-dimensional positioning of a certain node.

4. The UWB-based indoor positioning system according to claim 1, wherein the out-of-band network is a wired network or a wireless network.

5. The UWB-based indoor positioning system according to claim 1, wherein whenever a new response message is received from each of the nodes, the remote positioning server sequentially calculates the distance between the nodes using new timestamp information included in the new response message and the timestamp information stored in the remote positioning server.

6. The UWB-based indoor positioning system according to claim 2, wherein the remote positioning server goes around each of the nodes at intervals T and transmits the broadcast command message to each of the nodes.

7. An ultra-wide band (UWB)-based indoor positioning method using out-of-band management, comprising the steps of:
receiving, by a remote positioning server, a unicast message for registration from a plurality of nodes through an out-of-band network;
going around, by the remote positioning server, each of the nodes at intervals T and transmitting a broadcast command message to each of the nodes through the out-of-band network;
sequentially broadcasting, by each of the nodes that have received the broadcast command message, an UWB broadcast message through an ultra-wideband (UWB) channel;
sequentially receiving, by the remote location server, a broadcast completion report message from each of the nodes through the out-of-band network, after the completion of broadcasting;
sequentially receiving, by the remote positioning server, a response message to the UWB broadcast message from each of the nodes through the out-of-band network;
calculating, by the remote positioning server, a Time of Flight (ToF) between the nodes based on node identification information and timestamp information included in the response message;
calculating, by the remote location server, a distance between the nodes using the calculated ToF; and
producing, by the remote positioning server, positioning information for each of the nodes using the calculated distance between the nodes.

8. The UWB-based indoor positioning method using out-of-band management according to claim 7, wherein a minimum number of the plurality of the nodes is determined depending on a positioning dimension, and the nodes of which of number exceeds a threshold are registered for two-dimensional positioning of a certain node.

9. The UWB-based indoor positioning method using out-of-band management according to claim 7, wherein the out-of-band network is a wired network or a wireless network.

10. The UWB-based indoor positioning method using out-of-band management according to claim 7 wherein whenever a new response message is received from each of the nodes, the remote positioning server sequentially calculates the distance between the nodes using new timestamp information included in the new response message and the timestamp information stored in the remote positioning server.

11. The UWB-based indoor positioning method according to claim 7, wherein the remote positioning server goes around each of the nodes at intervals T and transmits the broadcast command message to each of nodes.
